(19) United States
(12) Patent Application Publication
(10) Pub. No.: US 2013/0226904 A1
(43) Pub. Date: Aug. 29, 2013

(54) DETERMINING DISTANCE BETWEEN DATA SEQUENCES

(71) Applicants: Abdullah A. MUEEN, Riverside, CA (US); Krishnamurthy Viswanathan, Mountain View, CA (US); Chetan K. Gupta, San Mateo, CA (US)

(72) Inventors: Abdullah A. MUEEN, Riverside, CA (US); Krishnamurthy Viswanathan, Mountain View, CA (US); Chetan K. Gupta, San Mateo, CA (US)

(21) Appl. No.: 13/406,142

(22) Filed: Feb. 27, 2012

(51) Int. Cl. G06F 17/30

(52) U.S. Cl. 707/721; 707/E17.017

(57) ABSTRACT

A lowest common ancestor of a first data sequence and a second data sequence is determined. Based on the lowest common ancestor, symbols that differ between the first data sequence and the second data sequence are identified. A distance between the first data sequence and the second data sequence is determined based on the symbols.

### BACKGROUND

The nearest neighbor query is an important functionality for time series analytics systems. The nearest neighbor query can fulfill a diagnostic role, where a system can select a segment of a time series that is perceived as interesting and search for past occurrences of similar segments. The identification of similar segments is accomplished by finding the nearest-neighbor (i.e., least distant or most similar segment), or its extension, the k-nearest neighbors. In addition to this diagnostic function, the nearest neighbor query is important for performing other operations such as motif discovery, frequent pattern discovery, outlier discovery and rule discovery. When processing time series, the nearest neighbor query is likely to be repeatedly invoked.

### BRIEF DESCRIPTION OF THE DRAWINGS

For a detailed description of various implementations, reference will now be made to the accompanying drawings in which:

FIG. 1 shows a block diagram for a system for determining nearest neighbor in accordance with principles disclosed herein;

FIG. 2 shows an example of a suffix tree in accordance with principles disclosed herein;

FIG. 3 shows a flow diagram for a method for determining distance between two data sequences in accordance with principles disclosed herein;

FIG. 4 shows flow diagram for a method for determining nearest neighbor in accordance with principles disclosed herein; and

FIG. 5 shows a flow diagram for a method for determining distance between two data segments in accordance with principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The recitation “based on” is intended to mean “based at least in part on.” Therefore, if X is based on Y, X may be based on Y and any number of additional factors.

### DETAILED DESCRIPTION

The following discussion is directed to various implementations of an efficient nearest neighbor determination technique. The principles disclosed herein have broad application, and the discussion of any implementation is meant only to be exemplary of that implementation, and not intended to intimate that the scope of the disclosure, including the claims, is limited to that implementation.

The nearest neighbor for time series data may be defined as follows. Given P, a segment of time series data (one or multi-dimensional), and a repository T of time series data (e.g., data obtained from historical measurements), the nearest neighbor of P may be defined as the time segment T* from T of the same width as P, that minimizes the distance d(P,T*) between P and itself. The function d(·) measures the distance between two time series sequences of the same width. The distance being measured may be the Euclidean distance. If the time series is one dimensional, then the Euclidean distance between two segments X=(x₁, x₂, . . . , xᵥ) and Y=(y₁, y₂, . . . , y_{w}) may be defined as:

$$d ( X , Y ) = {\sum }_{i = 1}^{w} {( {x}_{i} - {y}_{i} )}^{2} .$$

For multidimensional time-series, the distance may be a weighted sum of the distances of the one-dimensional time series. Both the repository T and the query P may both be normalized based on their respective sample means and variances.

Processing of complex queries often requires repeated invocation of the nearest neighbor algorithm which tends to increase the time required to process time series. Consequently, techniques for reducing nearest neighbor processing time are desirable. Implementations of the nearest neighbor determination disclosed herein convert the time series T and P into strings of symbols from a discrete finite alphabet by quantizing one or multiple consecutive values, and using the strings of symbols to compute a lower bound between P and a candidate segment. Various implementations apply string matching techniques to efficiently compute the lower bound.

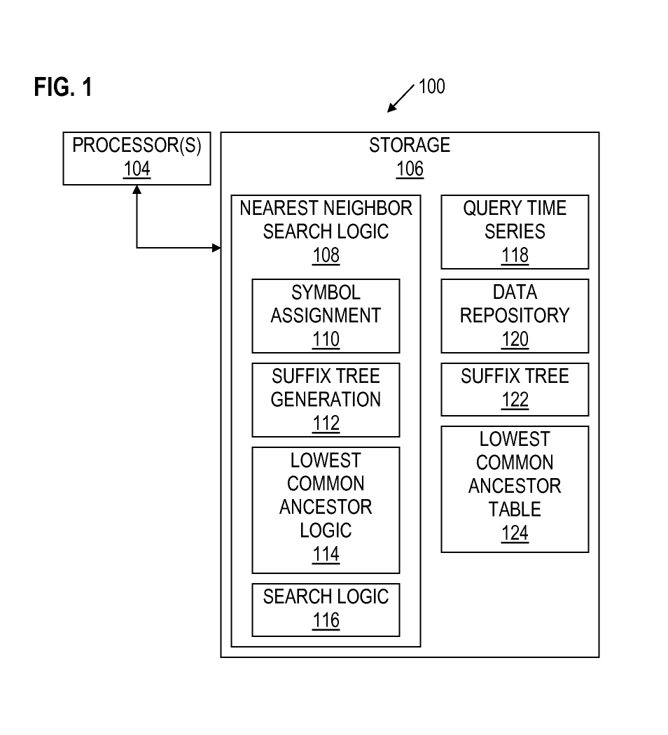

FIG. 1 shows a block diagram for a system 100 for determining nearest neighbor in accordance with principles disclosed herein. The system 100 includes processor(s) 104 and storage 106 coupled to the processor(s) 104. The system 100 may be formed in a computer such as a desktop computer, a laptop computer, a server, or any other suitable computing device.

The processor(s) 104 may include, for example, one or more general-purpose microprocessors, digital signal processors, microcontrollers, or other suitable instruction execution devices known in the art. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 106 is a non-transitory computer-readable storage device and includes volatile storage such as random access memory, non-volatile storage (e.g., a hard drive, an optical storage device (e.g., CD or DVD), FLASH storage, read-only-memory), or combinations thereof. The storage 106 includes nearest neighbor search logic 108 and various data processed by and produced by the processor(s) 104. The nearest neighbor search logic 108 includes instructions executable by the processor(s) 104 to identify nearest neighbors of the query time series 118 from the data repository 120. Processors execute software instructions. Software instructions alone are incapable of performing a function. Therefore, any reference to a function performed by software instructions, or to software instructions performing a function is simply a shorthand means for stating that the function is performed by a processor executing the instructions.

The nearest neighbor search logic 108 includes a symbol assignment module 110, a suffix tree generation module 112, a lowest common ancestor logic module 114, and a search logic module 116. The modules 110, 112, 114, 116 may be separate as shown, combined into fewer modules, or separated into more modules in various implementations of the nearest neighbor search logic 108. The nearest neighbor search logic 108 computes a distance between the query time series 118 and sequences stored on the data repository 120 to identify one or more nearest neighbors to the query time series 118.

The symbol assignment module 110 includes instructions that partition the values of the query time series 118 and the data repository 120 into contiguous portions comprising one or more values and assigns a symbol from a finite alphabet to each portion.

The suffix tree generation module 112 generates a suffix tree that represents the suffixes of both the data in the data repository 120 and the query time series 118. Suffix trees are digital search trees. A digital search tree representing a collection S of strings is a rooted directed tree where: 1) each internal node has two or more children; 2) each edge is labeled with a symbol or a string of symbols; 3) no two edges emanating from the same node are labeled by strings starting with the same symbol; and 4) the concatenation of the labels of the edges on any path from the root to a leaf yields a string in S and every string in S is represented by such a path. The digital search tree includes as many leaves as there are strings in S.

The suffix tree of a string X=x₁, x₂, . . . , xₙ is a digital search tree for the set of suffixes of X. In other words the set S is {x₁x₂ . . . xₙ, x₂x₃ . . . xₙ, . . . }. Every leaf of the suffix tree represents a suffix and can therefore be labeled by the index or indices corresponding to the suffix. The suffix tree of a string of length n can be constructed in O(n) time using McCreight's algorithm.

A pattern p=p₁, p₂, . . . , pₘ is a substring of X if the pattern is the prefix of a suffix of X. Hence p is a substring of X if there exists a path from the root of the suffix tree of X to an internal node or leaf such that the concatenation of the labels of the edges in the path equals p. Moreover, there may be substrings that are prefixes of the concatenation of labels on a path. Therefore, only O(m) computations are required to verify whether there is a path in the suffix tree corresponding to a given pattern of length m.

The lowest common ancestor logic module 114 is applied to the suffix tree 122 to generate a lowest common ancestor table 124 for the suffixes of the query time sequence 118 and the data repository 120. In some implementations, the A lowest common ancestor of two given suffixes is a lowest node of the suffix tree 112 that is common to the two given suffixes. Thus, given the symbolic representation of a pattern, for example, p₁p₂ . . . , the lowest common ancestor logic module 114 identifies the longest prefix of the pattern that exists exactly in T by following the path labeled p₁p₂ . . . pₖ until none of the following symbols in the suffix tree 122 equals pₖ₊₁. In some implementations, given two suffixes, the lowest common ancestor table 124 may return the length (e.g., the number of symbols) of the lowest common ancestors of the two given suffixes. In some implementations, the lowest common ancestor table may be a data structure including information from which the lowest common ancestor can be efficiently determined.

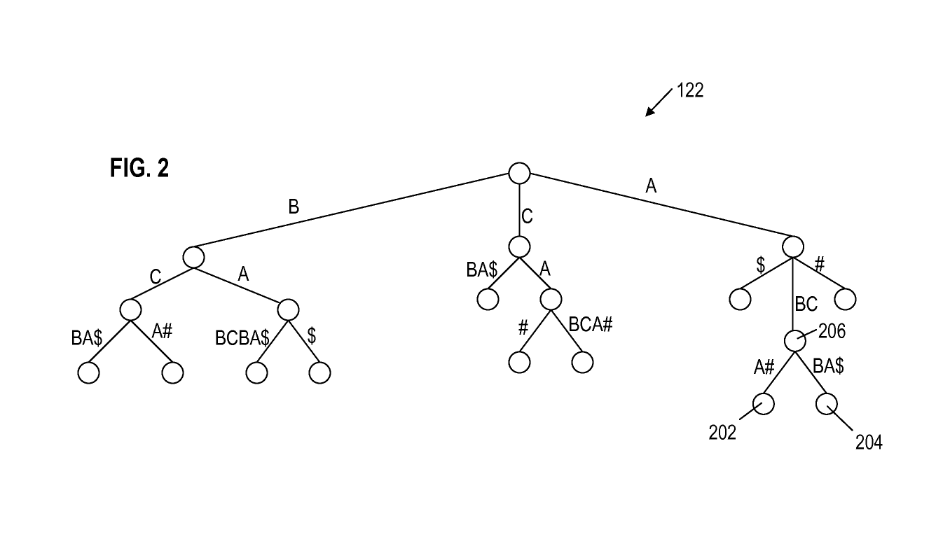

FIG. 2 shows an example of a suffix tree 122 produced by the suffix tree generation module 112 in accordance with principles disclosed herein. The suffix tree 200 includes the suffixes of a first symbol string CABCA# and a second symbol string BABCBA$ with the exception of the suffix # and the suffix $. The first string may represent the symbols of the query time series 118 and the second string may represent the symbols of the time series stored in the data repository 120. The suffix tree 122 can be used to identify lowest common ancestors of the suffixes of the first and second strings. For example, the node 202 represents the suffix ABCA# of the first string and the node 204 represents the suffix ABCBA$ of the second string. The node 206 represents the string ABC which is the lowest common ancestor of ABCA# and ABCBA$.

The search logic 116 applies the lowest common ancestor table 124 over the suffixes of the query time series 118 and the data repository 120 to identify data sequences of the data repository 120 that most closely approximate (i.e., are least distant from) the query time series 118. The search logic 116 compares the query time series 118 to each sequence of the data repository T of equal length to the time series 118. For each such sequence, the search logic 116 computes the distance between the sequences based only on those portions of the sequences not part of a lowest common ancestor of a suffix of the sequences. Thus, the search logic 116 retrieves, from the lowest common ancestor table 124, an indication of the length of the lowest common ancestor of two suffixes of the sequences. When a lowest common ancestor is identified, symbols of the identified lowest common ancestor are skipped, and a distance separating the symbols following the identified lowest common ancestor is computed and accumulated into the distance between the sequences. In this way, the search logic 116 provides accelerated determination of the distance between two sequences by computing the distance based only on portions of the sequences not part of a lowest common ancestor of suffixes of the sequences.

The search logic 116 may compute the distance (i.e., the lower bound d_{LB}) for the query time series 118 (P) and the data repository (T) with symbolic representations Y and A in accordance with the following;

1. Set i=1

2. Initialize d_{LB}(P,T)=0

3. while i<w (w is the length of Y):
(a) Determine the lowest common ancestor (LCA) of Yᵢ^{w} and Aᵢ^{w}, the length of the LCA is j
(b) If j<w, then increase d_{LB}(P,T) by an amount determined based on the symbols Y_{i±j} and Aᵢ₊ⱼ (or alternately increase by ((pᵢ₊ⱼ−tᵢ₊ⱼ)²)
(c) Set i=i+j+1

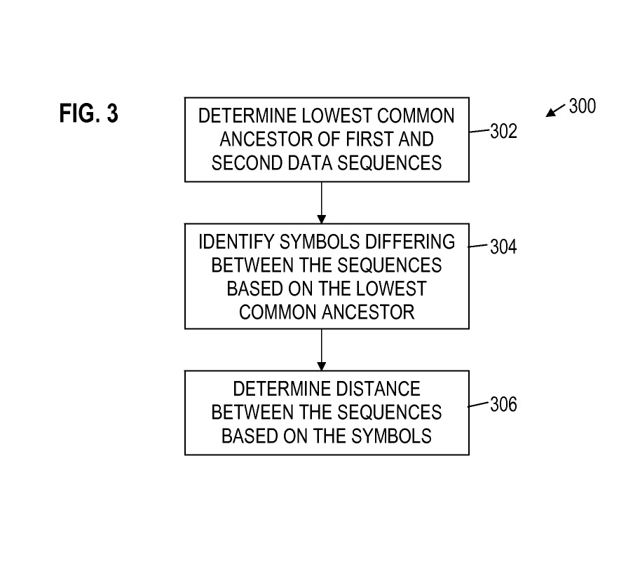

FIG. 3 shows a flow diagram for a method 300 for scheduling jobs in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 300 can be performed by the processor(s) 104 executing instructions read from a computer-readable medium (e.g., storage 106).

In block 302, the processor(s) 104 determine the lowest common ancestor of a first data sequence and a second data sequence. The first and second data sequences may be symbol strings respectively representing the query time series 118 and a segment of a time series of the data repository 120. The processor(s) 104 may access a lowest common ancestor table to determine the lowest common ancestor of the sequences.

In block 304, the processor(s) 104 identify symbols differing between the first data sequence and the second data sequence based on the determined lowest common ancestor. For example, if the determined lowest common ancestor is two symbols in length, then the third symbol of first data sequence (i.e., the symbol following the two symbol lowest common ancestor) must be different from the corresponding symbol of the second data sequence.

In block 306, the processor(s) 104 determine the distance between the first data sequence and the second data sequence based on the symbols identified as being different based on the lowest common ancestor. For example, the square of the difference of the time series data corresponding to the differing symbols may be accumulated into a difference value.

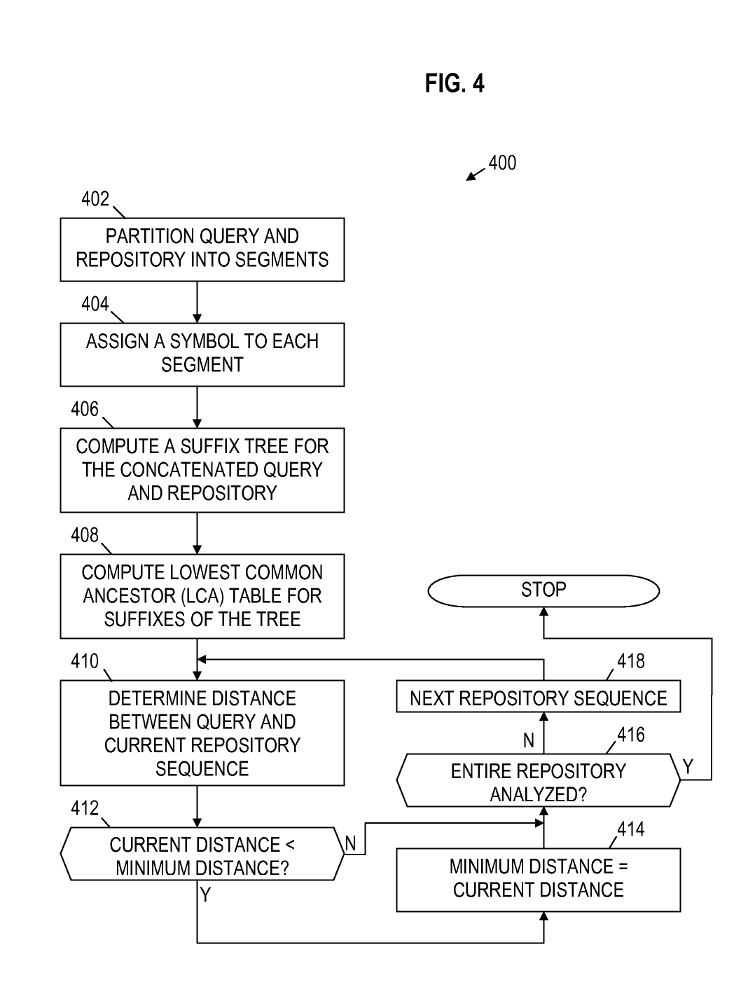

FIG. 4 shows flow diagram for a method 400 for determining nearest neighbor in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 400 can be performed by the processor(s) 104 executing instructions read from a computer-readable medium (e.g., storage 106).

In block 402, the processor(s) 104 partition the query time series 118 and the time series of data repository 120 into segments. Each segment may include one or more values of a time series. The processor(s) 104 assign a symbol to each segment to generate symbol strings representative of the time series in block 404.

In block 406, the processor(s) 104 computes a suffix tree for the suffixes of the symbol strings representing the query sequence and the data repository. The processor(s) may generate the suffix tree using McCreight's method, Ukkonen's method, etc.

In block 408, the processor(s) 104 computes a lowest common ancestor table for the suffixes contained in the suffix tree. For each suffix in the query symbol string or the repository symbol string, the lowest common ancestor table identifies a longest common prefix and/or a length of the longest common prefix of the strings.

In block 410, the processor(s) 104 determines a distance between the query time series and a current sequence of the repository time series. The distance is determined based on lowest common ancestors of the portions of the symbol strings representing the query time series and the current sequence of the repository time series.

In block 412, the processor(s) 104 determines whether the distance between the query time series and a current sequence of the repository time series is less than a minimum distance value. The minimum distance value may be a distance value between the query time series and a previously considered sequence of the repository time series.

If the distance between the query time series and a current sequence of the repository time series is less than a minimum distance value then, in block 414, the processor(s) 104 sets the minimum distance value to the distance between the query time series and a current sequence of the repository time series. The location and/or value of the current sequence of the repository time series may also be recorded.

In block 416, the processor(s) 104 determines whether the entire time series of the data repository has been analyzed with reference to the query time series. If the entire time series of the data repository has been analyzed with reference to the query time series, then processing is complete. Otherwise, a next sequence of the repository time series symbol string is selected for processing, and processing continues in block 410.

While the method 400 is directed to determination of a single minimum distance sequence of the data repository, some implementations of the method 400 may identify any number of minimum distance sequences of the data repository.

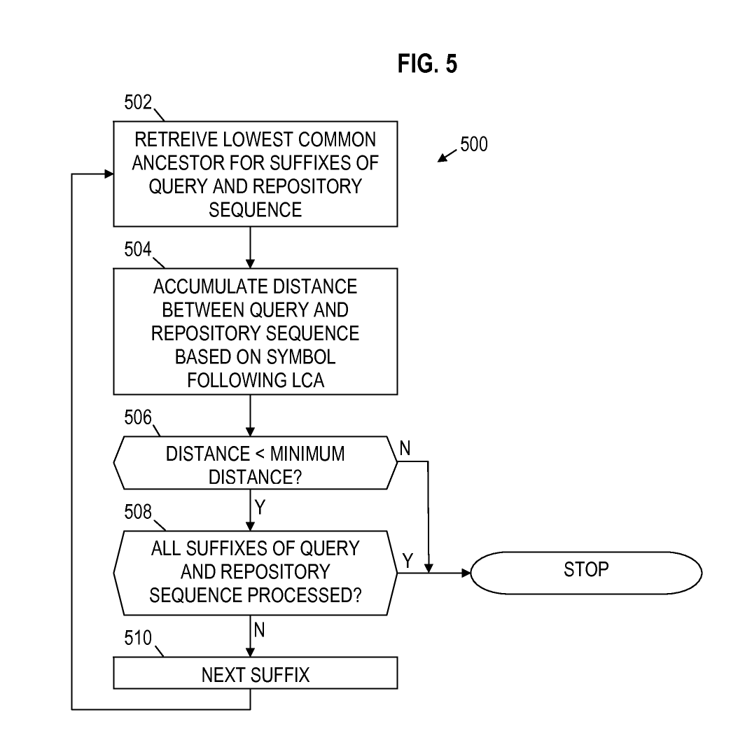

FIG. 5 shows a flow diagram for a method 500 for determining distance between two data segments in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 500 can be performed by the processor(s) 104 executing instructions read from a computer-readable medium (e.g., storage 106). The operations of the method 500 may be performed as part of block 410 of the method 400.

In block 502, the processor(s) 104 determines a lowest common ancestor value for currently considered suffixes of the query symbol sequence and the data repository symbol sequence. The lowest common ancestor value may be retrieved from the lowest common ancestor table 124. The lowest common ancestor value may include a lowest common ancestor sequence and/or the length thereof.

In block 504, the processor(s) 104 accumulates a distance value indicative of the distance between the query symbol sequence and the data repository symbol sequence. An amount added to the distance value may be based on the distance between the symbols of the query symbol sequence and the data repository symbol sequence subsequent to the lowest common ancestor of the sequences. Thus, implementations of the method perform no distance processing with regard to portions of the sequences corresponding to the lowest common ancestor value, thereby reducing the number of symbols processed with regard to distance and improving processing performance.

In block 506, the processor(s) 104 determines whether the accumulated distance value is less than a minimum distance value. The minimum distance value may be a distance value determined with regard to the query symbol sequence and a different data repository symbol sequence.

If the accumulated distance value is not less than the minimum distance value then distance processing with regard to the current data repository symbol sequence is complete. In some implementations, distance processing may continue over the length of the entire data repository symbol sequence.

If the accumulated distance value is less than the minimum distance value then the processor(s) 104 determines whether all suffixes of the query symbol sequence and the data repository symbol sequence have been processed. If all suffixes of the query symbol sequence and the data repository symbol sequence have been processed, the distance determination with regard to all suffixes of the query symbol sequence and the data repository symbol sequence is complete. Otherwise, the next suffixes of the query symbol sequence and the data repository symbol sequence are selected and processing continues in block 502.

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
determining, by a processor, a lowest common ancestor of a first data sequence and a second data sequence;
identifying, by the processor, based on the lowest common ancestor, symbols that differ between the first data sequence and the second data sequence; and
determining, by the processor, a distance between the first data sequence and the second data sequence based on the symbols;
wherein the first data sequence and the second data sequence are time series.

2. The method of claim 1, further comprising constructing, by the processor, a suffix tree comprising a first set of symbols that comprises the first data sequence and a second set of symbols that comprises the second data sequence.

3. The method of claim 2, further comprising generating, by the processor, a set of lowest common ancestor values relating suffixes of the first set of symbols to suffixes of the second set of symbols.

4. The method of claim 1, further comprising:
identifying each lowest common ancestor of the first data sequence and the second data sequence; and
determining a total distance between the first data sequence and the second data sequence as a sum of distances between differing symbols of the first and second data sequence immediately following each lowest common ancestor of the first and second data sequence.

5. The method of claim 1, further comprising selecting a nearest neighbor data sequence to the second data sequence from a plurality of data sequences, the selecting based on distances between each symbol subsequent to any lowest common ancestor of the second data sequence and each data sequence of the plurality of data sequence; wherein the plurality of data sequences are segments obtained from a single time series.

6. The method of claim 1, wherein determining the distance comprises omitting symbols of the lowest common ancestor from a distance computation.

7. A computer readable storage medium encoded with instructions that when executed cause a processor to:
determine a distance between a first data sequence and each data sequence of a plurality of data sequences; wherein the distance between the first data sequence a given data sequence of the plurality of data sequences is based only on a distance between symbols not included in a lowest common ancestor of the first data sequence and the given data sequence; and
select a nearest neighbor data sequence to the first data sequence from the plurality of data sequences based on a distance between the first data sequence and each data sequence of the plurality of data sequences.

8. The computer readable storage medium of claim 7, further comprising instructions that cause the processor to construct a suffix tree comprising the first data sequence and the plurality of data sequences.

9. The computer readable storage medium of claim 8, further comprising instructions that cause the processor to generate a set of lowest common ancestor values relating suffixes of the first data sequence to suffixes of the plurality of data sequences.

10. The computer readable storage medium of claim 7, further comprising instructions that cause the processor to determine a total distance between the first data sequence and a given data sequence of the plurality of data sequences as a sum of distances between differing symbols of the first data sequence and the given data sequence immediately following each lowest common ancestor of the first data sequence and the given data sequence.

11. The computer readable storage medium of claim 7, further comprising instructions that cause a processor to determine a distance between the first data sequence and a given data sequence of the plurality of data sequences based only on symbols not disposed within any lowest common ancestor of the first data sequence and the given data sequence.

12. A system, comprising:
nearest neighbor search logic; and
a processor to:
determine a distance between a query data sequence and each of a plurality of target data sequences, the distance between the query data sequence and a given target sequence of the plurality of target sequences based only on an accumulation of distances between symbols of the query data sequence and the given target data sequence that are not part of a lowest common ancestor of the query data sequence and the given target data sequence;
select one the target data sequences that most closely approximates a query data sequence based on the distance between the query data sequence and each of the target data sequences.

13. The system of claim 12, wherein the processor is further to:
construct a suffix tree comprising the query data sequence and the target data sequences; and
generate a set of lowest common ancestor values relating suffixes of the suffix tree.

14. The system of claim 12, wherein the processor is further to:
partition the query data sequence and the plurality of target data sequences into segments; and
assign a symbol to each segment based on the values of the segment.

15. The system of claim 12, wherein the nearest neighbor identification logic is further to:
identify each lowest common ancestor of the of the query data sequence and the given target data sequence; and
omit symbols of the lowest common ancestor from determination of the distance between the query data sequence and the given target data sequence.
